(19) United States
(12) Patent Application Publication
(10) Pub. No.: US 2026/0010794 A1
(43) Pub. Date: Jan. 8, 2026

(54) METHODS AND APPARATUS TO ANALYZE UNCERTAINTY IN MACHINE LEARNING MODELS

(71) Applicant: Intel Corporation, Santa Clara, CA (US)

(72) Inventors: Anthony Rhodes, Portland, OR (US); Sangita Ravi Sharma, Portland, OR (US); Lama Nachman, San Francisco, CA (US); Giuseppe Raffa, San Diego, CA (US)

(73) Assignee: Intel Corporation, Santa Clara, CA (US)

(21) Appl. No.: 19/328,927

(22) Filed: Sep. 15, 2025

(51) Int. Cl. G06N 3/082

(52) U.S. Cl. CPC G06N 3/082

(57) ABSTRACT

Quantification of uncertainty in multi-modal machine learning systems is disclosed. The approach involves generation of uncertainty estimates for individual modalities and the overall system prediction using a multi-modal fusion architecture and dropout analysis. The approach employs parallel model streams to independently process each modality, followed by a fusion layer and a final system prediction. Uncertainty quantification is then achieved through a statistical measure of dispersion (e.g., standard deviation) calculated from Monte Carlo Dropout samples. Furthermore, the approach determines modality importance using two novel metrics: Model Predictive Importance (MPI) and Uncertainty-based Modality Importance (UMI). MPI assesses similarity between modality predictions and the system-level prediction, while UMI quantifies the gradient of model variance with respect to internal layers within the fusion module. Finally, the generated uncertainty measures are combined to provide an assessment of uncertainty within the multi-modal system. The system enables robust uncertainty quantification for improved system classification performance.

### BACKGROUND

Machine learning models are utilized to analyze data (e.g., to determine a classification of the data). In some machine learning models, multiple types of data (e.g., modalities) are analyzed to determine a classification. Such machine learning models may be called multi-modal machine learning models.

### BRIEF DESCRIPTION OF THE DRAWINGS

FIG. 1 is a block diagram of an example environment in which an example uncertainty analyzer operates to analyze a machine learning model.

FIG. 2 is a block diagram of an example implementation of the uncertainty analyzer of FIG. 1.

FIG. 3 is an illustration of an example multi-modal classifier.

FIG. 4 is a flowchart representative of example machine readable instructions and/or example operations that may be executed, instantiated, and/or performed by example programmable circuitry to implement the uncertainty analyzer of FIG. 2.

FIG. 5 is a block diagram of an example processing platform including programmable circuitry structured to execute, instantiate, and/or perform the example machine readable instructions and/or perform the example operations of FIG. 4 to implement the uncertainty analyzer of FIG. 2.

FIG. 6 is a block diagram of an example implementation of the programmable circuitry of FIG. 5.

FIG. 7 is a block diagram of another example implementation of the programmable circuitry of FIG. 5.

FIG. 8 is a block diagram of an example software/firmware/instructions distribution platform (e.g., one or more servers) to distribute software, instructions, and/or firmware (e.g., corresponding to the example machine readable instructions of FIG. 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

The use of AI systems in real-world settings that encompass vital fields such as safety critical processes (e.g., autonomous driving and/or human-in-the-loop (HITL) workflows such as AI-assisted medical diagnostics) is strongly contingent on “trustworthiness” of those AI systems. In particular, in addition to exhibiting high performance grades (e.g., classification accuracy, precision) on real-world data, practical AI systems may furthermore provide nuanced guidance pertaining to the uncertainty of their predictions. It would be helpful for AI systems to competently “know what they don't know”. Among other applications, so-called “known unknowns” understanding can be employed for anomaly detection, to improve general model performance, to enhance model calibration properties, to trigger human intervention/annotation for HITL use cases, to detect data novelty/out of distribution (OOD) for continuous learning processes, etc.

Methods and apparatus disclosed herein (referred to as modality specific uncertainty quantification (MSUQ)) generate modality-specific uncertainty estimates for generalized multi-modal models. In some examples, the methods and apparatus can be applied to any multi-modal neural network workflows. In some implementations, MSUQ determines reliable modality-specific uncertainty scores for multi-modal machine learning systems such as neural network systems.

The methods and apparatus utilize a generalizable, multi-modal fusion architecture to enforce independent, modality-specific prediction streams in addition to multi-modal, system-level prediction. Using this baseline architecture, Monte Carlo dropout may be applied to render uncertainty estimates for each modality and system-level predictive uncertainty following a fusion module. Because uncertainty in multi-modal systems may be additionally impacted by modality “importance”, the methods and apparatus may generate estimates of importance scores for the modalities of interest, which are referred to as model predictive importance (MPI) and uncertainty-based modality importance (UMI). A resulting MSUQ score may then be calculated as modality uncertainty weighted by the modality importance.

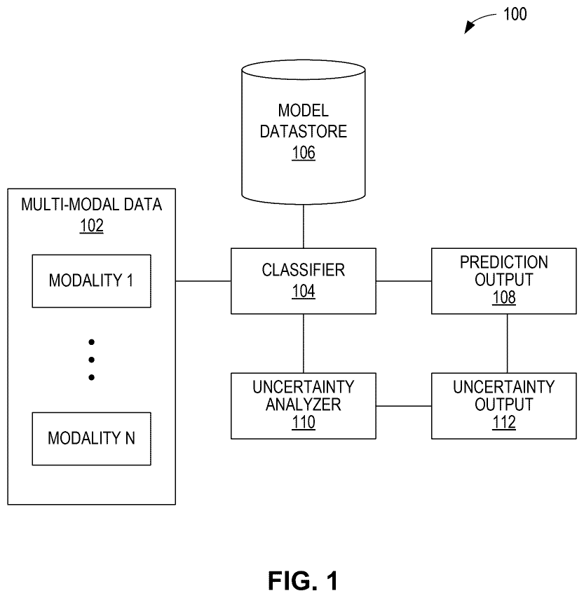

FIG. 1 is a block diagram of an example environment 100 in which an example uncertainty analyzer circuitry 110 operates to generate an uncertainty output 112 for a classifier circuitry 104. The example environment 100 includes an example multi-modal data 102, the example classifier circuitry 104, an example model datastore 106, an example prediction output 108, the example uncertainty analyzer circuitry 110, and the example uncertainty output 112.

The example multi-modal data 102 includes two modalities (e.g., images and audio). Alternatively, the multi-modal data 102 may include any number of modalities and types of modalities that are related to a classification system.

The example classifier circuitry 104 is a machine learning classifier such as a neural network classifier. Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

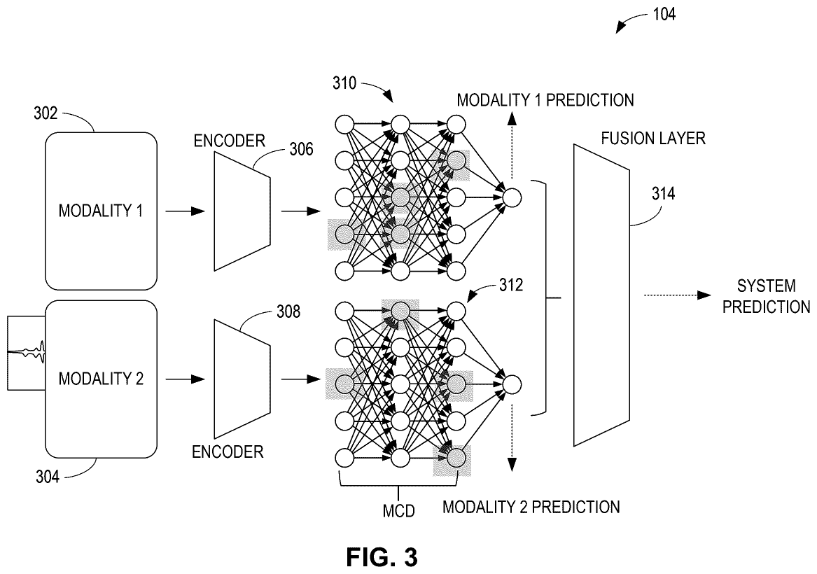

The classifier circuitry 104 analyzes the multi-modal data 102 based on a trained model stored in the model datastore 106 to generate the prediction output 108. An example implementation of the classifier circuitry 104 is described in conjunction with FIG. 3. The classifier circuitry 104 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the classifier circuitry may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions.

The model datastore 106 may be implemented by any type of data storage such as a database, a file storage, local storage, cloud storage, edge storage, or any combination of storage types.

The prediction output 108 is a classification result from the classifier circuitry 104. The particular classification result depends on the type of the classification system and the multi-modal data 102. For example, the prediction output 108 may be a classification of the content of a video where analysis is performed on the images and audio of a video.

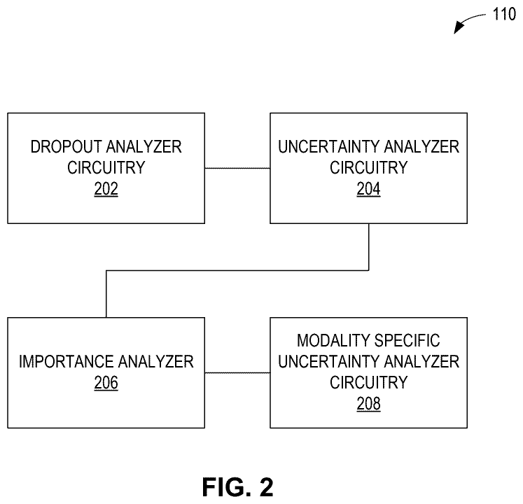

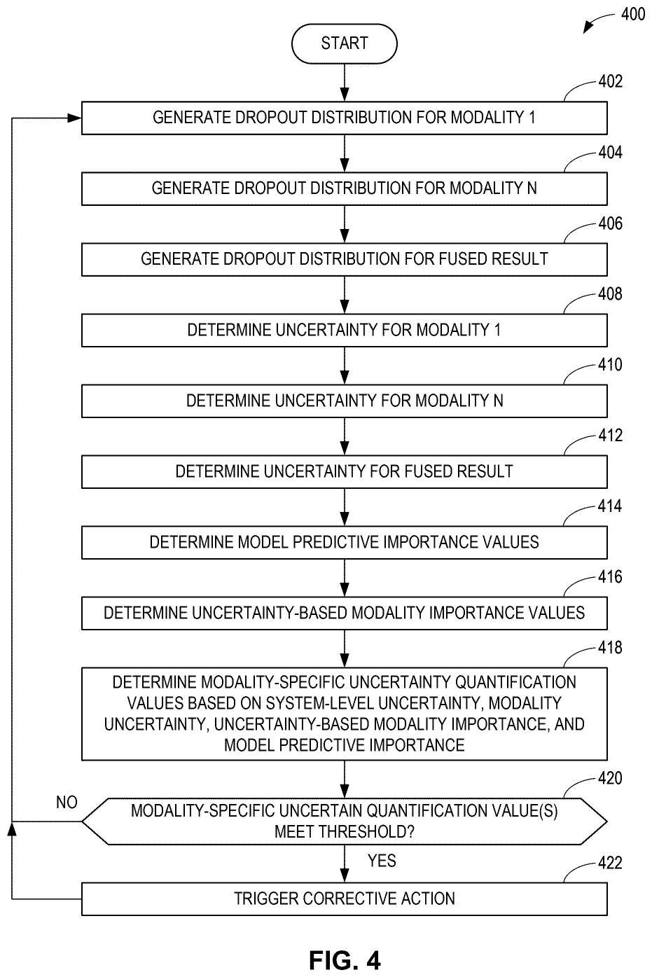

The uncertainty analyzer circuitry 110 of the illustrated example determines the uncertainty output 112 that indicates an uncertainty score for the classifier circuitry 104 and the corresponding model(s) from the model datastore 106. The uncertainty output 112 includes a reliable system-level and modality-specific uncertainty quantification (UQ) and provides accurate approximation of “modality influence” for system classification. Further details of the uncertainty analyzer circuitry 110 are discussed in conjunction with FIG. 2 and the flowchart of FIG. 4.

FIG. 2 is a block diagram of an example implementation of the uncertainty analyzer circuitry 110 of FIG. 1 to generate an uncertainty output indicative of an uncertainty score of the classifier circuitry 104 and model stored in the model datastore circuitry 106. The uncertainty analyzer circuitry 110 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the uncertainty analyzer 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The uncertainty analyzer circuitry 110 of FIG. 2 includes an example dropout analyzer circuitry 202, an example uncertainly analyzer circuitry 204, an example importance analyzer circuitry 206, and an example modality specific uncertainty analyzer circuitry 208.

The example dropout analyzer circuitry 202 performs dropout analysis for each of the modalities of the multi-modal data 102 and the classification system as a whole. For example, the dropout analyzer circuitry 202 of the illustrated example performs Monte Carlo dropout analysis. Alternatively, any other type of dropout analysis may be performed such as, for example, Bayesian analysis, deep ensemble analysis, variational inference, etc.

In some examples, the dropout analyzer circuitry 202 is instantiated by programmable circuitry executing dropout analysis instructions and/or configured to perform operations such as those represented by the flowchart of FIG. 4.

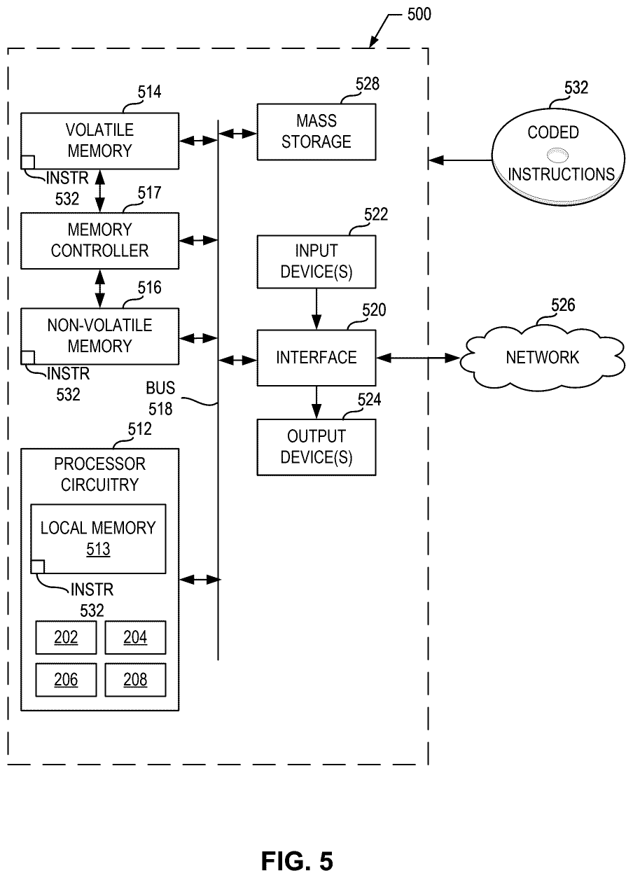

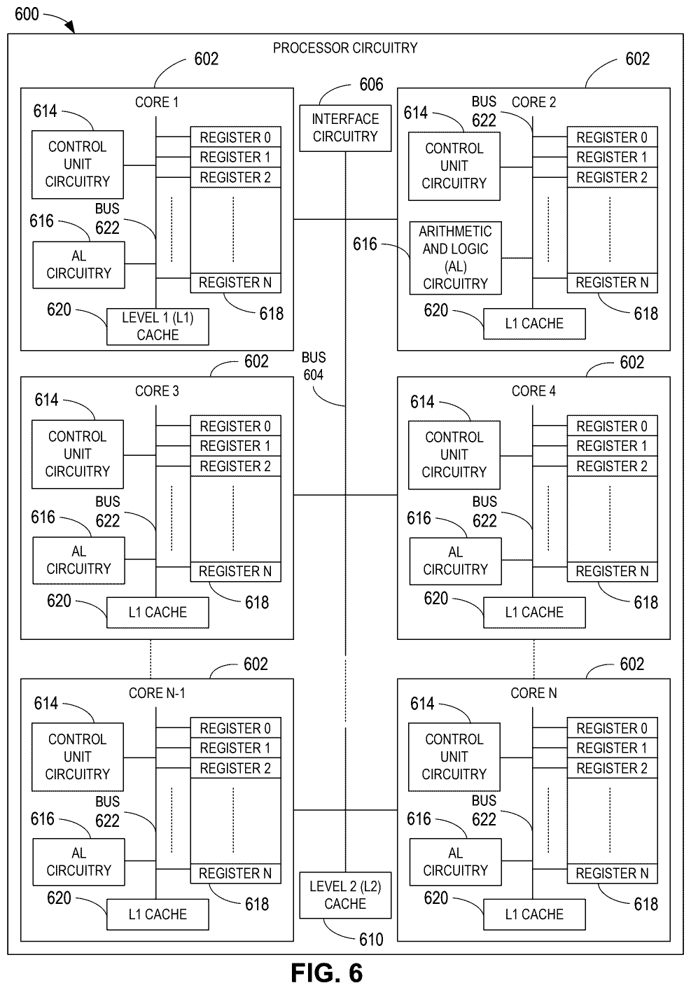

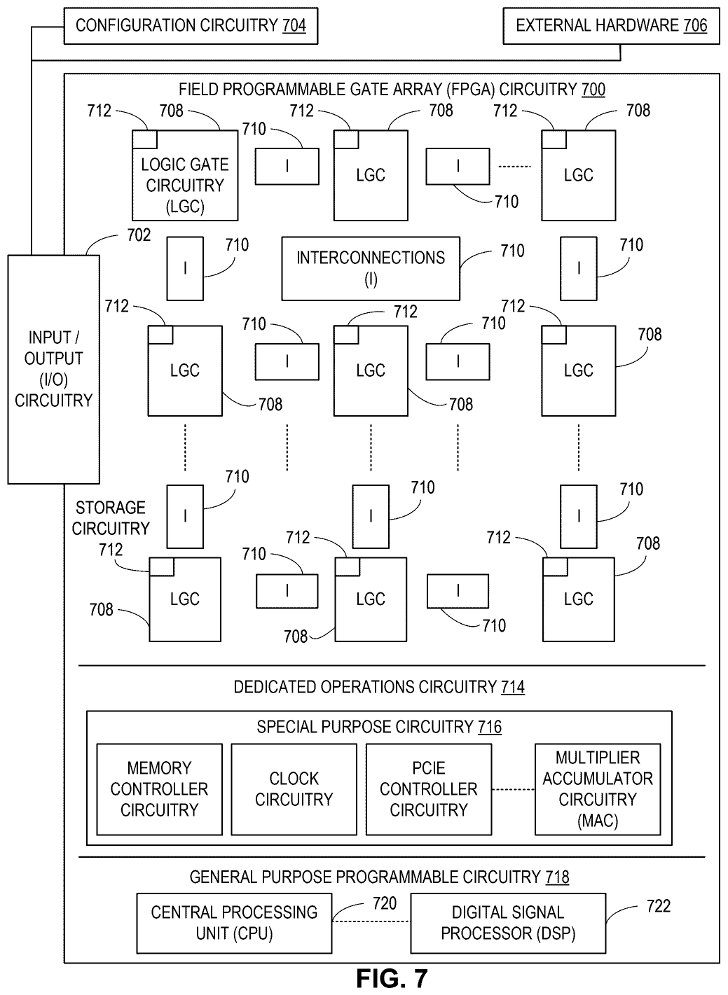

In some examples, the uncertainty analyzer circuitry 110 includes means for dropout analysis. For example, the means for dropout analysis may be implemented by dropout analyzer circuitry 202. In some examples, the dropout analyzer circuitry 202 may be instantiated by programmable circuitry such as the example programmable circuitry 512 of FIG. 5. For instance, the dropout analyzer circuitry 202 may be instantiated by the example microprocessor 600 of FIG. 6 executing machine executable instructions such as those implemented by at least blocks 402-406 of FIG. 4. In some examples, dropout analyzer circuitry 202 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the dropout analyzer circuitry 202 may be instantiated by any other combination of hardware, software, and/or firmware. For example, the dropout analyzer circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example uncertainty analyzer circuitry 204 determines uncertainty estimates based on the results of the dropout analysis by the dropout analyzer circuitry 202. Specifically, the example uncertainty analyzer circuitry 204 estimates a modality uncertainty score (UQ) for each modality and system-level uncertainty using a statistical measure of dispersion (e.g., standard deviation). For example, UQ of a modality may be calculated as:

$$UQ ( modality ) = std ( {\{ {f}_{mod}^{( i )} ( x ) \}}_{i = 1}^{M} ) ,$$

where “modality” can be any of the data modalities (including the fused result), M indicates the number of Monte Carlo samples used in MCD, x is in the input datum,

$${f}_{mod}^{( i )}$$

denotes a modality-specific prediction generated by a fusion model (e.g., as shown in FIG. 3), and i is the index of the Monte Carlo sample. Alternatively, any other type of dispersion estimate may be utilized (e.g., in conjunction with Bayesian analysis).

In some examples, the uncertainty analyzer circuitry 204 is instantiated by programmable circuitry executing uncertainty analysis instructions and/or configured to perform operations such as those represented by the flowchart of FIG. 4.

In some examples, the uncertainty analyzer circuitry 110 includes means for uncertainty analysis. For example, the means for uncertainty analysis may be implemented by uncertainty analyzer circuitry 204. In some examples, the uncertainty analyzer circuitry 204 may be instantiated by programmable circuitry such as the example programmable circuitry 512 of FIG. 5. For instance, the uncertainty analyzer circuitry 204 may be instantiated by the example microprocessor 600 of FIG. 6 executing machine executable instructions such as those implemented by at least blocks 408-412 of FIG. 4. In some examples, uncertainty analyzer circuitry 204 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the uncertainty analyzer circuitry 204 may be instantiated by any other combination of hardware, software, and/or firmware. For example, the uncertainty analyzer circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The importance analyzer circuitry 206 performs one or more importance analyses to determine the importance impact of the modalities on a resulting classification (e.g., how closely is the system level prediction correlated with a prediction of a modality). The example importance 206 of FIG. 2 utilizes two importance calculations referred to as model predictive importance (MPI) and uncertainty-based modality importance (UMI).

MPI attempts to capture a similarity between each modality prediction and a fusion model system-level prediction to ascertain the influence of each modality with regard to system-level inference. To determine MPI, the importance analyzer circuitry 206 calculates cross-entropy loss between the modality-level output prediction and a one-hot encoded version of the system-level output (e.g., treating this output as a uniform, “ground-truth” for system-level inference). For example, MPI may be defined as:

$$MPI = \frac{CE ( \overline{{f}_{mod - 1} ( x )} , OH [ \overline{{f}_{sys} ( x )} ] ) - CE ( \overline{{f}_{mod - 2} ( x )} , OH [ \overline{{f}_{sys} ( x )} ] )}{{μ}^{*}} ,$$

where the subscript denotes the corresponding output of modality/system module of the fusion model and CE is the cross-entropy function. In each of the modalities/system, the importance analyzer circuitry 206 calculates CE loss with respect to the mean of the Monte Carlo samples generated by the dropout analyzer circuitry 202 (indicated by the horizontal bar). OH[⋅] represents the one-hot encoding transform and

$${μ}^{*} = ( E ( \overline{{f}_{mod - 1} ( x )} , OH [ \overline{{f}_{sys} ( x )} ] ) + E ( \overline{{f}_{mod - 2} ( x )} , OH [ \overline{{f}_{sys} ( x )} ] ) ) / 2 ,$$

i.e., the mean of the CE losses.

MPI assesses the similarity between each modality prediction and the fusion model system-level prediction, and then calculates the difference between these similarity scores, normalized by the mean of the similarity calculations. In this way, MPI produces a skewed measure so that relatively large negative values indicate a significant predictive influence for modality 1, whereas a relatively large positive value reveals conversely that modality 2 has a significant influence on the system-level prediction. If MPI≈0, then the modalities exert a comparable influence on the system-level prediction.

While MPI captures modality importance with respect to total system prediction, MPI may not account for modality influence per system uncertainty. To this end, the importance analyzer circuitry 206 also calculates UMI to generate a gradient-based formulation that may identify modality importance for system uncertainty. UMI formally quantifies the extent to which system modalities contribute to system-level uncertainty using gradient-propagation methods. Accordingly, to compute UMI, the importance analyzer circuitry 206 calculates the gradient of the variance of the model's Monte Carlo output samples with respect to internal model layers (specifically the multi-modal fusion layer) and pools the gradient in the fusion layer according to modality contributions to render a modality importance score per modality.

UMI may be calculated as

$$UMI = \frac{{\sum }_{i = 1}^{M} {( {f}_{sys}^{( i )} ( x ) - {μ}_{f} )}^{2}}{M} \to \frac{2 {\sum }_{i = 1}^{M} ( {f}_{sys}^{( i )} ( x ) - {μ}_{f} ) ( {∇}_{{x}^{‵}} [ {f}_{sys}^{( i )} ( x ) ] - {∇}_{{x}^{‵}} [ {μ}_{f} ] )}{M} ,$$

where M
indicates the number of Monte Carlo samples;

$${f}_{sys}^{( i )} ( x )$$

is the vector system output of the ith Monte Carlo sample prediction for the input datum x; μ_{f} is the mean of the Monte Carlo system prediction outputs; ∇_{\dot{x}} denotes the gradient with respect to the model fusion layer parameters. The example UMI calculation results in a matrix of gradient values of dimension m×n, where m indicates the number of fusion dimensions and n represents the model output prediction vector size. To generate modality-specific UMI scalar value scores, the importance analyzer circuitry 206 pools this matrix of gradients by taking the average of the elements of the matrix over the respective modality dimensions.

In some examples, the importance analyzer circuitry 206 is instantiated by programmable circuitry executing importance analysis instructions and/or configured to perform operations such as those represented by the flowchart of FIG. 4.

In some examples, the uncertainty analyzer circuitry 110 includes means for importance analysis. For example, the means for importance analysis may be implemented by importance analyzer circuitry 206. In some examples, the importance analyzer circuitry 206 may be instantiated by programmable circuitry such as the example programmable circuitry 512 of FIG. 5. For instance, the importance analyzer circuitry 206 may be instantiated by the example microprocessor 600 of FIG. 6 executing machine executable instructions such as those implemented by at least blocks 414-416 of FIG. 4. In some examples, importance analyzer circuitry 206 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the importance analyzer circuitry 206 may be instantiated by any other combination of hardware, software, and/or firmware. For example, the importance analyzer circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example modality specific uncertainty analyzer circuitry 208 aggregates the metrics output by the uncertainty analyzer circuitry 204 and the importance analyzer circuitry 206 to determine a modality specific uncertainty quantification (MSUQ) for each modality. The example modality specific uncertainty analyzer circuitry 208 calculates the MSUQ of a modality as:

$$MSUQ ( modality ) = {α}_{1} UQ ( system ) + {α}_{2} UQ ( modality ) + {α}_{3} UMI ( modaality ) + {α}_{4} MPI ( modality ) ,$$

where α values are tunable parameters. For example, the a parameters may be tuned heuristically to match an expected result, may be selected by an optimization scheme such as hyperparameter optimization, etc. The MSUQ score of a modality is output as the uncertainty output 112. The uncertainty output 112 may be utilized by a system to take action (e.g., when the MSUQ score for a modality meets a threshold). For example, when the MSUQ score for a modality meets a threshold the modality specific uncertainty analyzer circuitry 208 may generate an alert (e.g., indicating/identifying data drift), trigger retraining of the neural network for the identified modality, etc.

In some examples, the modality specific uncertainty analyzer circuitry 208 is instantiated by programmable circuitry executing modality specific uncertainty analysis instructions and/or configured to perform operations such as those represented by the flowchart of FIG. 4.

In some examples, the uncertainty analyzer circuitry 110 includes means for modality specific uncertainty analysis. For example, the means for modality specific uncertainty analysis may be implemented by modality specific uncertainty analyzer circuitry 208. In some examples, the modality specific uncertainty analyzer circuitry 208 may be instantiated by programmable circuitry such as the example programmable circuitry 512 of FIG. 5. For instance, the modality specific uncertainty analyzer circuitry 208 may be instantiated by the example microprocessor 600 of FIG. 6 executing machine executable instructions such as those implemented by at least blocks 418-422 of FIG. 4. In some examples, modality specific uncertainty analyzer circuitry 208 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the modality specific uncertainty analyzer circuitry 208 may be instantiated by any other combination of hardware, software, and/or firmware. For example, the modality specific uncertainty analyzer circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the uncertainty analyzer circuitry 110 of FIG. 1 is illustrated in FIG. 2, one or more of the elements, processes, and/or devices illustrated in FIG. 2 may be combined, divided, re-arranged, omitted, eliminated, and/or implemented in any other way. Further, the example dropout analyzer circuitry 202, the example uncertainty analyzer circuitry 204, the example importance analyzer circuitry 206, the example modality specific uncertainty analyzer circuitry 208, and/or, more generally, the example uncertainty analyzer circuitry 110 of FIG. 2, may be implemented by hardware alone or by hardware in combination with software and/or firmware. Thus, for example, any of the example dropout analyzer circuitry 202, the example uncertainty analyzer circuitry 204, the example importance analyzer circuitry 206, the example modality specific uncertainty analyzer circuitry 208, and/or, more generally, the example uncertainty analyzer circuitry 110, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example uncertainty analyzer circuitry 110 of FIG. 2 may include one or more elements, processes, and/or devices in addition to, or instead of, those illustrated in FIG. 2, and/or may include more than one of any or all of the illustrated elements, processes and devices.

FIG. 3 is an illustration of an example multi-modal classifier that may implement the classifier circuitry 104 of FIG. 1. The example multi-modal classifier 104 of FIG. 3 includes a first encoder 306 that encodes first data of a first modality 302 and a second encoder 308 that encodes second data of a second modality 304. The encoded data from the encoders 306, 308 is fed to a first neural network 310 and a second neural network 312 respectively. Predictions from the first neural network 310 and the second neural network 312 are combined with a fusion layer 314 to generate a combined/fused system-level prediction. FIG. 3 includes illustration of highlighted nodes indicative of the effect of a Monte Carlo dropout analysis. During analysis by the uncertainty analyzer 110, the Monte Carlo dropout analysis of each of the first neural network 310 and the second neural network 312 is performed by the dropout analyzer circuitry 202 and analyzed by the uncertainty analyzer circuitry 204 to determine the uncertainty estimation of each of the neural networks.

A flowchart representative of example machine readable instructions, which may be executed by programmable circuitry to implement and/or instantiate the uncertainty analyzer circuitry 110 of FIG. 2 and/or representative of example operations which may be performed by programmable circuitry to implement and/or instantiate the uncertainty analyzer circuitry 110 of FIG. 2, is shown in FIG. 4. The machine readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA) discussed below in connection with FIGS. 6 and/or 7. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 4, many other methods of implementing the example uncertainty analyzer circuitry 110 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to generate modality-specific uncertainty quantification scores and to take action based on the scores. The example machine-readable instructions and/or the example operations 400 of FIG. 4 begin at block 402, at which the dropout analyzer circuitry 202 generates a dropout distribution for a data of a first modality. The dropout analyzer circuitry 202 further generates dropout distributions for any additional modalities (indicated by block 404). Further, the dropout analyzer circuitry 202 generates a dropout distribution for the fused/system-level result (block 406).

The uncertainty analyzer circuitry 204 then determines an uncertainty estimation for the first modality based on the distribution from block 402 (block 408). For example, the uncertainty estimation may be determined based on a standard deviation of the distribution. The uncertainty analyzer circuitry 204 then determines uncertainty estimations for the remainder of the modalities (block 410) and for the fused result (block 412).

The importance analyzer circuitry 206 then determines modality predictive importance values for each of the modalities (block 414). The importance analyzer circuitry 206 further determines uncertainty-based modality importance values for each of the modalities (block 416).

The modality specific uncertainty analyzer circuitry 208 determines MSUQ scores based on system-level uncertainty, modality uncertainty, uncertainty-based modality importance and model predictive importance (block 418).

The modality specific uncertainty analyzer circuitry 208 determines if any of the modality-specific uncertainty quantification value(s) meet a threshold (block 420). If none of the MSUQ scores meet the threshold, control returns to block 402. Alternatively, if a MSUQ score, the modality specific uncertainty analyzer circuitry 208 triggers a corrective action (block 422) and control returns to block 402.

FIG. 5 is a block diagram of an example programmable circuitry platform 500 structured to execute and/or instantiate the example machine-readable instructions and/or the example operations of FIG. 4 to implement the uncertainty analyzer circuitry 110 of FIG. 2. The programmable circuitry platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, VPUs, DSPs, and/or microcontrollers from any desired family or manufacturer. The programmable circuitry 512 may be implemented by one or more semiconductor based (e.g., silicon based) devices. In this example, the programmable circuitry 512 implements the dropout analyzer circuitry 202, the uncertainty analyzer circuitry 204, the importance analyzer circuitry 206, and the modality specific uncertainty analyzer circuitry 208.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 532, which may be implemented by the machine readable instructions of FIG. 4, may be stored in the mass storage device 528, in the volatile memory 514, in the non-volatile memory 516, and/or on at least one non-transitory computer readable storage medium such as a CD or DVD which may be removable.

FIG. 6 is a block diagram of an example implementation of the programmable circuitry 512 of FIG. 5. In this example, the programmable circuitry 512 of FIG. 5 is implemented by a microprocessor 600. For example, the microprocessor 600 may be a general-purpose microprocessor (e.g., general-purpose microprocessor circuitry). The microprocessor 600 executes some or all of the machine-readable instructions of the flowcharts of FIG. 4 to effectively instantiate the circuitry of FIG. 2 as logic circuits to perform operations corresponding to those machine readable instructions. In some such examples, the circuitry of FIG. 2 is instantiated by the hardware circuits of the microprocessor 600 in combination with the machine-readable instructions. For example, the microprocessor 600 may be implemented by multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowcharts of FIG. 4.

The cores 602 may communicate by a first example bus 604. In some examples, the first bus 604 may be implemented by a communication bus to effectuate communication associated with one(s) of the cores 602. For example, the first bus 604 may be implemented by at least one of an Inter-Integrated Circuit (I2C) bus, a Serial Peripheral Interface (SPI) bus, a PCI bus, or a PCIe bus. Additionally or alternatively, the first bus 604 may be implemented by any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the local memory 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating-point operations. In yet other examples, the AL circuitry 616 may include first AL circuitry that performs integer-based operations and second AL circuitry that performs floating-point operations. In some examples, the AL circuitry 616 may be referred to as an Arithmetic Logic Unit (ALU).

The registers 618 are semiconductor-based structures to store data and/or instructions such as results of one or more of the operations performed by the AL circuitry 616 of the corresponding core 602. For example, the registers 618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure, such as by being distributed throughout the core 602 to shorten access time. The second bus 622 may be implemented by at least one of an I2C bus, a SPI bus, a PCI bus, or a PCIe bus.

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages.

The microprocessor 600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 600, in the same chip package as the microprocessor 600 and/or in one or more separate packages from the microprocessor 600.

FIG. 7 is a block diagram of another example implementation of the programmable circuitry 512 of FIG. 5. In this example, the programmable circuitry 512 is implemented by FPGA circuitry 700. For example, the FPGA circuitry 700 may be implemented by an FPGA. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 600 of FIG. 6 described above (which is a general purpose device that may be programmed to execute some or all of the machine readable instructions represented by the flowchart(s) of FIG. 4 but whose interconnections and logic circuitry are fixed once fabricated), the FPGA circuitry 700 of the example of FIG. 7 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 4. In particular, the FPGA circuitry 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 4. As such, the FPGA circuitry 700 may be configured and/or structured to effectively instantiate some or all of the operations/functions corresponding to the machine readable instructions of the flowchart(s) of FIG. 4 as dedicated logic circuits to perform the operations/functions corresponding to those software instructions in a dedicated manner analogous to an ASIC. Therefore, the FPGA circuitry 700 may perform the operations/functions corresponding to the some or all of the machine readable instructions of FIG. 4 faster than the general-purpose microprocessor can execute the same.

In the example of FIG. 7, the FPGA circuitry 700 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

The FPGA circuitry 700 of FIG. 7, includes example input/output (I/O) circuitry 702 to obtain and/or output data to/from example configuration circuitry 704 and/or external hardware 706. For example, the configuration circuitry 704 may be implemented by interface circuitry that may obtain a binary file, which may be implemented by a bit stream, data, and/or machine-readable instructions, to configure the FPGA circuitry 700, or portion(s) thereof. In some such examples, the configuration circuitry 704 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 706 may be implemented by external hardware circuitry. For example, the external hardware 706 may be implemented by the microprocessor 600 of FIG. 6.

The FPGA circuitry 700 also includes an array of example logic gate circuitry 708, a plurality of example configurable interconnections 710, and example storage circuitry 712. The logic gate circuitry 708 and the configurable interconnections 710 are configurable to instantiate one or more operations/functions that may correspond to at least some of the machine readable instructions of FIG. 4 and/or other desired operations. The logic gate circuitry 708 shown in FIG. 7 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations/functions. The logic gate circuitry 708 may include other electrical structures such as look-up tables (LUTs), registers (e.g., flip-flops or latches), multiplexers, etc.

The configurable interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example dedicated operations circuitry 714. In this example, the dedicated operations circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the programmable circuitry 512 of FIG. 5, many other approaches are contemplated. For example, FPGA circuitry may include an on-board CPU, such as one or more of the example CPU 720 of FIG. 6. Therefore, the programmable circuitry 512 of FIG. 5 may additionally be implemented by combining at least the example microprocessor 600 of FIG. 6 and the example FPGA circuitry 700 of FIG. 7. In some such hybrid examples, one or more cores 602 of FIG. 6 may execute a first portion of the machine readable instructions represented by the flowchart(s) of FIG. 4 to perform first operation(s)/function(s), the FPGA circuitry 700 of FIG. 7 may be configured and/or structured to perform second operation(s)/function(s) corresponding to a second portion of the machine readable instructions represented by the flowcharts of FIG. 4, and/or an ASIC may be configured and/or structured to perform third operation(s)/function(s) corresponding to a third portion of the machine readable instructions represented by the flowcharts of FIG. 4.

It should be understood that some or all of the circuitry of FIG. 2 may, thus, be instantiated at the same or different times. For example, same and/or different portion(s) of the microprocessor 600 of FIG. 6 may be programmed to execute portion(s) of machine-readable instructions at the same and/or different times. In some examples, same and/or different portion(s) of the FPGA circuitry 700 of FIG. 7 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 600 of FIG. 6 may execute machine readable instructions in one or more threads executing concurrently and/or in series. In some examples, the FPGA circuitry 700 of FIG. 7 may be configured and/or structured to carry out operations/functions concurrently and/or in series. Moreover, in some examples, some or all of the circuitry of FIG. 2 may be implemented within one or more virtual machines and/or containers executing on the microprocessor 600 of FIG. 6.

In some examples, the programmable circuitry 512 of FIG. 5 may be in one or more packages. For example, the microprocessor 600 of FIG. 6 and/or the FPGA circuitry 700 of FIG. 7 may be in one or more packages. In some examples, an XPU may be implemented by the programmable circuitry 512 of FIG. 5, which may be in one or more packages. For example, the XPU may include a CPU (e.g., the microprocessor 600 of FIG. 6, the CPU 720 of FIG. 7, etc.) in one package, a DSP (e.g., the DSP 722 of FIG. 7) in another package, a GPU in yet another package, and an FPGA (e.g., the FPGA circuitry 700 of FIG. 7) in still yet another package.

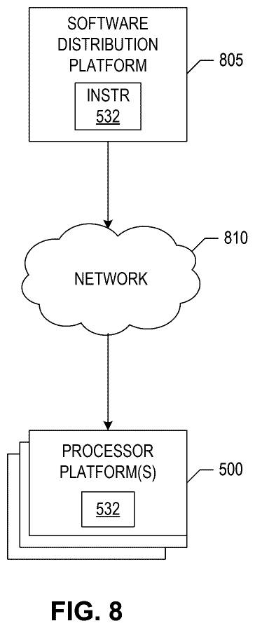

A block diagram illustrating an example software distribution platform 805 to distribute software such as the example machine readable instructions 532 of FIG. 5 to other hardware devices (e.g., hardware devices owned and/or operated by third parties from the owner and/or operator of the software distribution platform) is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine readable instructions 532, which may correspond to the example machine readable instructions of FIG. 4, as described above. The one or more servers of the example software distribution platform 805 are in communication with an example network 810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 532 from the software distribution platform 805. For example, the software, which may correspond to the example machine readable instructions of FIG. 4, may be downloaded to the example programmable circuitry platform 500, which is to execute the machine readable instructions 532 to implement the uncertainty analyzer. In some examples, one or more servers of the software distribution platform 805 periodically offer, transmit, and/or force updates to the software (e.g., the example machine readable instructions 532 of FIG. 5) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to methods and apparatus to analyze uncertainty in machine learning models are disclosed herein. Further examples and combinations thereof include the following:

Example 1 includes a non-transitory machine readable storage medium comprising instructions to cause programmable circuitry to at least determine uncertainty estimates for a plurality of modalities of a multi-modal machine learning classifier based on prediction distributions determined based on dropout analysis, determine modality importance scores for the plurality of modalities using two or more importance scores, determine modality-specific uncertainty scores for the plurality of modalities based on a combination of the uncertainty estimates and the modality importance scores, and trigger a corrective action based on the modality-specific uncertainty scores.

Example 2 includes the non-transitory machine readable storage medium of example 1, wherein the dropout analysis is Monte Carlo dropout analysis.

Example 3 includes the apparatus of any one or more of examples 1-2, wherein the uncertainty estimates include uncertainty estimates for each modality of the plurality of modalities and the multi-modal machine learning classifier utilizes parallel model streams that process each modality separately.

Example 4 includes the apparatus of any one or more of examples 1-3, wherein the instructions cause the programmable circuitry to trigger the corrective action when one of the modality-specific uncertainty scores meets a threshold.

Example 5 includes the apparatus of any one or more of examples 1-4, wherein the corrective action is retraining of the multi-modal machine learning classifier.

Example 6 includes the apparatus of any one or more of examples 1-5, wherein the corrective action is triggering an alert identifying one of the plurality of modalities.

Example 7 includes the apparatus of any one or more of examples 1-6, wherein the multi-modal machine learning classifier is to identify anomalies in multi-modal input data and the corrective action is triggering an alert identifying data drift.

Example 8 includes the apparatus of any one or more of examples 1-7, wherein one of the modality importance scores is calculated based on a gradient of a variance of the dropout analysis.

Example 9 includes the apparatus of any one or more of examples 1-8, wherein one of the modality importance scores is an indication of a similarity of a prediction of one of the modalities to a prediction of an overall prediction of the multi-modal machine learning classifier.

Example 10 includes an apparatus comprising interface circuitry to obtain a multi-modal machine learning classifier, instructions, programmable circuitry to at least one of execute or instantiate the instructions to determine uncertainty estimates for a plurality of modalities of the multi-modal machine learning classifier based on prediction distributions determined based on dropout analysis, determine modality importance scores for the plurality of modalities using two or more importance scores, determine modality-specific uncertainty scores for the plurality of modalities based on a combination of the uncertainty estimates and the modality importance scores, and trigger a corrective action based on the modality-specific uncertainty scores.

Example 11 includes the apparatus of example 10, wherein the dropout analysis is Monte Carlo dropout analysis.

Example 12 includes the apparatus of any one or more of examples 10-11, wherein the uncertainty estimates include uncertainty estimates for each modality of the plurality of modalities and the multi-modal machine learning classifier utilizes parallel model streams that process each modality separately.

Example 13 includes the apparatus of any one or more of examples 10-12, wherein the instructions cause the programmable circuitry to trigger the corrective action when one of the modality-specific uncertainty scores meets a threshold.

Example 14 includes the apparatus of any one or more of examples 10-13, wherein the corrective action is retraining of the multi-modal machine learning classifier.

Example 15 includes the apparatus of any one or more of examples 10-14, wherein the corrective action is triggering an alert identifying one of the plurality of modalities.

Example 16 includes the apparatus of any one or more of examples 10-15, wherein the multi-modal machine learning classifier is to identify anomalies in multi-modal input data and the corrective action is triggering an alert identifying data drift.

Example 17 includes the apparatus of any one or more of examples 10-16, wherein one of the modality importance scores is calculated based on a gradient of a variance of the dropout analysis.

Example 18 includes the apparatus of any one or more of examples 10-17, wherein one of the modality importance scores is an indication of a similarity of a prediction of one of the modalities to a prediction of an overall prediction of the multi-modal machine learning classifier.

Example 19 includes a system comprising a classifier to perform classification using a multi-modal machine learning mode, and an uncertainty analyzer to determine uncertainty estimates for a plurality of modalities of a multi-modal machine learning classifier based on prediction distributions determined based on dropout analysis, determine modality importance scores for the plurality of modalities using two or more importance scores, determine modality-specific uncertainty scores for the plurality of modalities based on a combination of the uncertainty estimates and the modality importance scores, and trigger a corrective action based on the modality-specific uncertainty scores.

Example 20 includes the system of example 19, wherein the dropout analysis is Monte Carlo dropout analysis.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory machine readable storage medium comprising instructions to cause programmable circuitry to at least:
determine uncertainty estimates for a plurality of modalities of a multi-modal machine learning classifier based on prediction distributions determined based on dropout analysis;
determine modality importance scores for the plurality of modalities using two or more importance scores;
determine modality-specific uncertainty scores for the plurality of modalities based on a combination of the uncertainty estimates and the modality importance scores; and
trigger a corrective action based on the modality-specific uncertainty scores.

2. The non-transitory machine readable storage medium of claim 1, wherein the dropout analysis is Monte Carlo dropout analysis.

3. The non-transitory machine readable storage medium of claim 1, wherein the uncertainty estimates include uncertainty estimates for each modality of the plurality of modalities and the multi-modal machine learning classifier utilizes parallel model streams that process each modality separately.

4. The non-transitory machine readable storage medium of claim 1, wherein the instructions cause the programmable circuitry to trigger the corrective action when one of the modality-specific uncertainty scores meets a threshold.

5. The non-transitory machine readable storage medium of claim 1, wherein the corrective action is retraining of the multi-modal machine learning classifier.

6. The non-transitory machine readable storage medium of claim 1, wherein the corrective action is triggering an alert identifying one of the plurality of modalities.

7. The non-transitory machine readable storage medium of claim 1, wherein the multi-modal machine learning classifier is to identify anomalies in multi-modal input data and the corrective action is triggering an alert identifying data drift.

8. The non-transitory machine readable storage medium of claim 1, wherein one of the modality importance scores is calculated based on a gradient of a variance of the dropout analysis.

9. The non-transitory machine readable storage medium of claim 1, wherein one of the modality importance scores is an indication of a similarity of a prediction of one of the modalities to a prediction of an overall prediction of the multi-modal machine learning classifier.

10. An apparatus comprising:
interface circuitry to obtain a multi-modal machine learning classifier;
instructions;
programmable circuitry to at least one of execute or instantiate the instructions to:
determine uncertainty estimates for a plurality of modalities of the multi-modal machine learning classifier based on prediction distributions determined based on dropout analysis;
determine modality importance scores for the plurality of modalities using two or more importance scores;
determine modality-specific uncertainty scores for the plurality of modalities based on a combination of the uncertainty estimates and the modality importance scores; and
trigger a corrective action based on the modality-specific uncertainty scores.

11. The apparatus of claim 10, wherein the dropout analysis is Monte Carlo dropout analysis.

12. The apparatus of claim 10, wherein the uncertainty estimates include uncertainty estimates for each modality of the plurality of modalities and the multi-modal machine learning classifier utilizes parallel model streams that process each modality separately.

13. The apparatus of claim 10, wherein the instructions cause the programmable circuitry to trigger the corrective action when one of the modality-specific uncertainty scores meets a threshold.

14. The apparatus of claim 10, wherein the corrective action is retraining of the multi-modal machine learning classifier.

15. The apparatus of claim 10, wherein the corrective action is triggering an alert identifying one of the plurality of modalities.

16. The apparatus of claim 10, wherein the multi-modal machine learning classifier is to identify anomalies in multi-modal input data and the corrective action is triggering an alert identifying data drift.

17. The apparatus of claim 10, wherein one of the modality importance scores is calculated based on a gradient of a variance of the dropout analysis.

18. The apparatus of claim 10, wherein one of the modality importance scores is an indication of a similarity of a prediction of one of the modalities to a prediction of an overall prediction of the multi-modal machine learning classifier.

19. A system comprising:
a classifier to perform classification using a multi-modal machine learning mode; and
an uncertainty analyzer to:
determine uncertainty estimates for a plurality of modalities of a multi-modal machine learning classifier based on prediction distributions determined based on dropout analysis;
determine modality importance scores for the plurality of modalities using two or more importance scores;
determine modality-specific uncertainty scores for the plurality of modalities based on a combination of the uncertainty estimates and the modality importance scores; and
trigger a corrective action based on the modality-specific uncertainty scores.

20. The system of claim 19, wherein the dropout analysis is Monte Carlo dropout analysis.
